(19) United States
(12) Patent Application Publication
(10) Pub. No.: US 2012/0064418 A1
(43) Pub. Date: Mar. 15, 2012

(54) FUEL CELL SYSTEM FOR IMPROVING FUEL SUPPLY

(76) Inventors: Jin S. HEO, Hwaseong-si (KR); Hye-jung Cho, Anyang-si (KR); Young-jae Kim, Seoul (KR); Jung-kurn Park, Osan-si (KR)

(21) Appl. No.: 13/209,832

(22) Filed: Aug. 15, 2011

(30) Foreign Application Priority Data
Sep. 10, 2010 (KR) 10-2010-0088989

(51) Int. Cl. H01M 8/06; F16K 11/22

(52) U.S. Cl. 429/415; 137/896; 137/606

(57) ABSTRACT

A fuel cell system includes a fuel cell for generating electric power by using a fuel, a valve module that controls a flow of a low concentration fuel circulating through the fuel cell, and a flow of a high concentration fuel supplied from a fuel storage unit to the fuel cell, a pump for pumping at least one of the low concentration fuel and the high concentration fuel according to a fuel flow control of the valve module; and a mixer for mixing and supplying the low concentration fuel and the high concentration fuel pumped from the pump to the fuel cell.

### CROSS-REFERENCE TO RELATED APPLICATIONS

This application claims the benefit of Korean Patent Application No. 10-2010-0088989, filed on Sep. 10, 2010, in the Korean Intellectual Property Office, the disclosure of which is incorporated herein in its entirety by reference.

### BACKGROUND

1. Field

The present disclosure relates to a fuel cell system for improving fuel supply to a fuel cell.

2. Description of the Related Art

Fuel cells are drawing attention together with solar cells, as an eco-friendly alternative energy technology that generates electric power from a material that is abundant on earth, such as hydrogen, or the like. A material such as a fuel, water, air, or the like is supplied to a fuel cell in order for the fuel cell to generate electric power, but if such a material is not smoothly supplied to the fuel cell, the fuel cell may not operate.

### SUMMARY

According to an embodiment, there is provided a fuel cell system including a fuel cell for generating electric power by using a fuel, a valve module for controlling a flow of a low concentration fuel circulating through the fuel cell, and a flow of a high concentration fuel supplied from a fuel storage unit to the fuel cell; a pump for pumping at least one of the low concentration fuel and the high concentration fuel according to a fuel flow control of the valve module; and a mixer for mixing and supplying the low concentration fuel and the high concentration fuel pumped from the pump to the fuel cell.

The valve module may manually control the flow of the low concentration fuel and the flow of the high concentration fuel according to a manipulation of a user.

The valve module may automatically control the flow of the low concentration fuel and the flow of the high concentration fuel according to a concentration of a fuel supplied to the fuel cell.

When the flow of the high concentration fuel is less than a predetermined value, the valve module may increase the flow of the high concentration fuel by blocking the flow of the low concentration fuel such that a greater pumping force is exerted with respect to the high concentration fuel.

The fuel cell system may further include a controller for controlling fuel supply to the fuel cell. The valve module may include at least one electrical valve for controlling the flow of the low concentration fuel and the flow of the high concentration fuel according to a control of the controller.

The valve module may include a first electrical valve for controlling the flow of the low concentration fuel according to the control of the controller, and a second electrical valve for controlling the flow of the high concentration fuel according to the control of the controller.

The valve module may include an electrical valve that allows the flow of the low concentration fuel while blocking the flow of the high concentration fuel, or blocks the flow of the low concentration fuel while allowing the flow of the high concentration fuel, according to the control of the controller.

According to another embodiment, there is provided a valve module for controlling a flow of a low concentration fuel circulating through a fuel cell and a flow of a high concentration fuel supplied from a fuel storage unit to the fuel cell. The valve module may include a fuel stopper for selectively blocking the flow of the low concentration fuel, and a double valve for allowing at least one of the flow of the low concentration fuel and the flow of the high concentration fuel according to the blocking of the fuel stopper.

The fuel stopper may include a button that moves according to a manipulation of a user, and a pipe that is opened or closed according to the movement of the button.

The valve module may further include a controller for controlling fuel supply to the fuel cell, wherein the fuel stopper includes a button that moves according to the control of the controller, and a pipe that is opened or closed according to the movement of the button.

The double valve may include a first path through which the low concentration fuel flows and a second path through which the high concentration fuel flows, wherein outlets of the first and second paths are connected to an inlet of a pump, and a check valve disposed in the second path, the check valve being opened according to a size of an inflow pressure of the high concentration fuel.

The check valve may be disposed at a location where the first path and the second path meet, and may be positioned to be wetted by the low concentration fuel flowing through the first path.

### BRIEF DESCRIPTION OF THE DRAWINGS

These and other aspects will become apparent and more readily appreciated from the following description of the embodiments, taken in conjunction with the accompanying drawings of which:

FIG. 1 illustrates a block diagram of a fuel cell system according to an embodiment;

FIG. 2 illustrates an internal configuration diagram of a valve module of FIG. 1;

FIGS. 3A and 3B illustrate diagrams of a fuel stopper of FIG. 2, according to an embodiment;

FIGS. 4A and 4B illustrate diagrams of the fuel stopper of FIG. 2, according to another embodiment;

FIGS. 5A and 5B illustrate diagrams of the fuel stopper of FIG. 2, according to another embodiment;

FIGS. 6A and 6B illustrate diagrams of a double valve of FIG. 2, according to an embodiment;

FIG. 7 illustrates a block diagram of a fuel cell system according to another embodiment;

FIG. 8 illustrates a diagram of a valve module used in the fuel cell system of FIG. 7, according to an embodiment; and

FIGS. 9A and 9B illustrate diagrams of the valve module used in the fuel cell system of FIG. 7, according to another embodiment.

### DETAILED DESCRIPTION

Reference will now be made in detail to embodiments, examples of which are illustrated in the accompanying drawings, wherein like reference numerals refer to like elements throughout.

A fuel cell system generally includes a fuel cell, a balance of peripheral devices (BOP) for supplying a fuel, water, air, or the like to the fuel cell, and a converter for converting electric power output from the fuel cell and supplying the converted electric power to a load. Some of the following embodiments are related to the BOP for supplying a fuel, water, air, or the like. Generally, the fuel cell is designed in a stack shape, wherein a plurality of cells are combined in series or parallel, according to electric power demanded by the load. Hereinafter, a cell and a stack in which a plurality of cells are combined are both simply called a fuel cell.

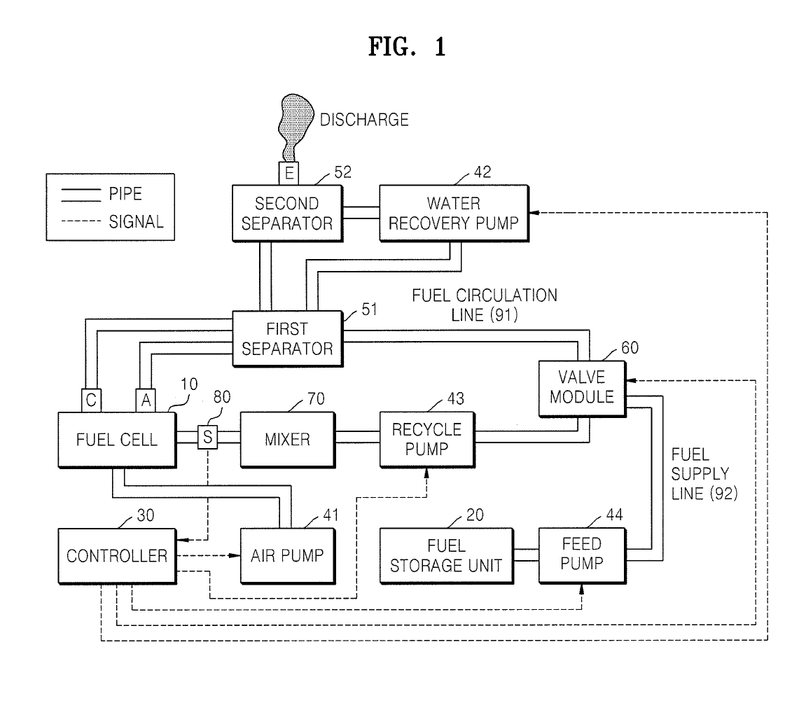

FIG. 1 is a block diagram of a fuel cell system according to an embodiment. Referring to FIG. 1, the fuel cell system includes a fuel cell 10, a fuel storage unit 20, a controller 30, an air pump 41, a water recovery pump 42, a recycle pump 43, a feed pump 44, a first separator 51, a second separator 52, a valve module 60, a mixer 70, and a sensor 80. As described above, the fuel cell system includes elements of a BOP for supplying a fuel, water, air, or the like to the fuel cell 10. As shown in FIG. 1, several pipes are installed to connect the elements of the BOP. Also, the fuel cell system of FIG. 1 may include elements other than those shown in FIG. 1. For example, the fuel cell system of FIG. 1 may further include a heat exchanger for recovering heat released by a reaction of the fuel cell 10.

The fuel cell 10 is a power generating device for generating a direct current (DC) power by directly converting chemical energy of a fuel into electric energy by using an electrochemical reaction. Examples of the fuel cell 10 are a solid oxide fuel cell (SOFC), a polymer electrolyte membrane fuel cell (PEMFC), and a direct methanol fuel cell (DMFC). Specifically, the fuel cell system in FIG. 1 is a fuel cell system including a BOP for driving a DMFC. However, an element for smoothly supplying a fuel to the fuel cell 10, which will be described in detail below, may be applied to any other type of fuel cell.

Meanwhile, unlike an indirect methanol fuel cell that reforms methanol to increase a hydrogen concentration, a fuel cell 10 such as a DMFC generates hydrogen ions and electrons as methanol and water directly react with each other in an anode of the fuel cell 10 without having to reform methanol. As such, since a process of reforming methanol is not required in the fuel cell 10, the fuel cell 10 may be miniaturized, and may be used in a portable fuel cell system.

In the anode of the fuel cell 10, a reaction of CH₃OH+H₂O->6H⁺+6e⁻+CO₂ occurs, and in a cathode of the fuel cell 10, a reaction of 3/2O₂+6H⁺+6e⁻->3H₂O occurs. Protons (H⁺) are transmitted through a proton exchange membrane inside the fuel cell 10, and electrons are transmitted from the anode to the cathode through an external circuit. Accordingly, electric power is generated. Specifically, the fuel cell 10 includes a catalyst that allows the reactions in the fuel cell 10 to occur well. The catalyst may be formed of platinum. The catalyst may deteriorate if a temperature thereof is too high during the above reactions. For the reactions, methanol diluted with water, instead of pure methanol, is supplied to the fuel cell 10. In order to perform the reactions in the fuel cell 10 well, suitable amounts of a fuel (CH₃OH), water (H₂O), and air (O₂) are supplied to the fuel cell 10.

In order to adjust the amounts of a fuel (CH₃OH), water (H₂O), and air (O₂) supplied to the fuel cell 10, the controller 30 controls the air pump 41, the feed pump 44, the recycle pump 43, and the water recovery pump 42. Specifically, in order to supply a fuel having a concentration demanded by the fuel cell 10, the controller 30 controls an operation of the feed pump 44 based on a value detected by the sensor 80, which detects a concentration of a fuel flowing into the fuel cell 10.

The fuel cell 10 generates electric power by using a fuel having a suitable concentration discharged from the mixer 70. While generating the electric power, carbon dioxide, as a by-product of the reactions, and unreacted methanol are discharged from the anode of the fuel cell 10, and water, as another by-product of the reactions, is discharged from the cathode of the fuel cell 10.

The first separator 51 separates methanol and water from the by-products and the unreacted methanol discharged from the fuel cell 10, thereby recovering methanol and water. The second separator 52 further recovers water by separating water again from the remaining by-products discharged from the first separator 51 via a heat exchange process, or the like, and externally discharges carbon dioxide, that is, a remaining by-product, after the recovery. The water recovery pump 42 pumps the water recovered by the second separator 52 to the first separator 51. Accordingly, a low concentration fuel including the methanol recovered by the first separator 51 and the water recovered by the first and second separators 51 and 52 is discharged from the first separator 51.

The fuel storage unit 20 is a container for storing a fuel. The fuel storage unit may have any shape, such as a cylindrical shape, a box shape, or the like. The fuel storage unit 20 may have a shape that allows the fuel storage unit 20 to be easily refilled. The fuel storage unit 20 may be a cartridge that is detached from the fuel cell system. The fuel storage unit 20 stores an undiluted high concentration fuel, such as, for example, 100% methanol.

When the fuel storage unit 20 is attached to the fuel cell system, an internal pressure of the fuel storage unit 20 may be higher than internal pressures of other elements, such as the mixer 70. Here, the fuel stored in the fuel storage unit 20 may flow into the mixer 70 through a fuel supply line 92 according to the internal pressure of the fuel storage unit 20. Also, when the fuel cell system is portable, the fuel storage unit 20 may be disposed in a position that is higher than other elements, such as the mixer 70. Here, the fuel stored in the fuel storage unit 20 may flow into the mixer 70 through the fuel supply line 92 according to gravity. As such, if the fuel flows into the mixer 70 without regards to the concentration control of the controller 30, the mixer 70 may supply a high concentration fuel having a concentration higher than what is demanded by the fuel cell 10, thereby affecting a life and performance of the fuel cell 10.

Accordingly, a check valve may be inserted between the feed pump 44 and the mixer 70 and may be opened to allow fuel to be passed therethrough only when a pressure higher than the internal pressure of the fuel storage unit 20 or gravity is applied thereto. Generally, such a check valve includes a ball that operates as a shutter inside a pipe, wherein a path at an outlet is wider than a path at an inlet, and a spring that supports the ball. When a predetermined opening pressure exceeding a force of the spring supporting the ball in the check valve is applied, an opening may be formed between the ball and the path at the inlet and thus a fuel may flow through the opening.

Since methanol is volatile, methanol easily evaporates at a room temperature. Accordingly, if the fuel cell system is not operated for a long period of time or if the fuel cell system is stored in a hot and dry place, fuel in the check valve and the fuel supply line 92 connected to the check valve completely dries out. In this case, the ball in the check valve may completely adhere to the path through which the fuel flows, and thus the check valve may open only when a pressure higher than the pressure described above is applied. Such locking of the check valve not only deteriorates the performance of a pump that supplies a fuel, but also prevents an initial pumping operation of the pump.

To solve the locking of the check valve, priming may be performed by filling the feed pump 44 with a fluid during an initial operation of the pump. Self-priming is a function of automatically performing the priming. However, self-priming may be impaired if the fuel inside the check valve of the fuel cell system and the fuel supply line 92 connected to the check valve is completely dried out. Thus, in the fuel cell system according to the current embodiment of FIG. 1, the check valve installed to the fuel supply line 92 is omitted, and the valve module 60 is installed at a point where a fuel circulation line 91 and the fuel supply line 92 are connected.

The valve module 60 is inserted at the point where the fuel circulation line 91 and the fuel supply line 92 are connected so as to control a flow of the low concentration fuel supplied to the fuel cell 10 through the fuel circulation line 91, and a flow of the high concentration fuel supplied from the fuel storage unit 20 to the fuel cell 10 through the fuel supply line 92. Here, the fuel circulation line 91 denotes pipes on a path where an unreacted fuel discharged from the fuel cell 10 flows again to the fuel cell 10, and the fuel supply line 92 denotes pipes on a path where a fuel is newly supplied from the fuel storage unit 20 to the fuel cell 10.

The recycle pump 43 pumps at least one of the low concentration fuel (transported from the valve module 60 through the fuel circulation line 91) and the high concentration fuel (transported through the fuel supply line 92) to the mixer 70 according to the fuel flow control of the valve module 60. The mixer 70 mixes the low concentration fuel and the high concentration fuel discharged from the recycle pump 43, and supplies a fuel having a suitable concentration generated via such a mixing process to the fuel cell 10.

The valve module 60 may manually control the flow of the low concentration fuel circulating through the fuel circulation line 91 and the flow of the high concentration fuel supplied through the fuel supply line 92, according to user manipulation. Alternatively, the valve module 60 may automatically control the flow of the low concentration fuel circulating through the fuel circulation line 91 and the flow of the high concentration fuel supplied through the fuel supply line 92, according to a concentration of a fuel detected by the sensor 80, i.e., a concentration of a fuel supplied to the fuel cell 10.

Specifically, in order to prevent the check valve from being locked or the feed pump 44 from being unable to perform the self-priming, the valve module 60 blocks the flow of the low concentration fuel circulating through the fuel circulation line 91 when the flow of the high concentration fuel supplied through the fuel supply line 92 is below a predetermined value. Accordingly, the recycle pump 43 may exert a pumping force primarily on pumping the high concentration fuel supplied through the fuel supply line 92, and thus the high concentration fuel may flow to the recycle pump 43 through the valve module 60. The fuel pumped by the recycle pump 43 and flowing through the fuel supply line 92 wets the feed pump 44, which may be completely dry, and the check valve, and thus the operation of the feed pump 44 may be normalized and the check valve may be unlocked. A structure of the valve module 60 will now be described in detail.

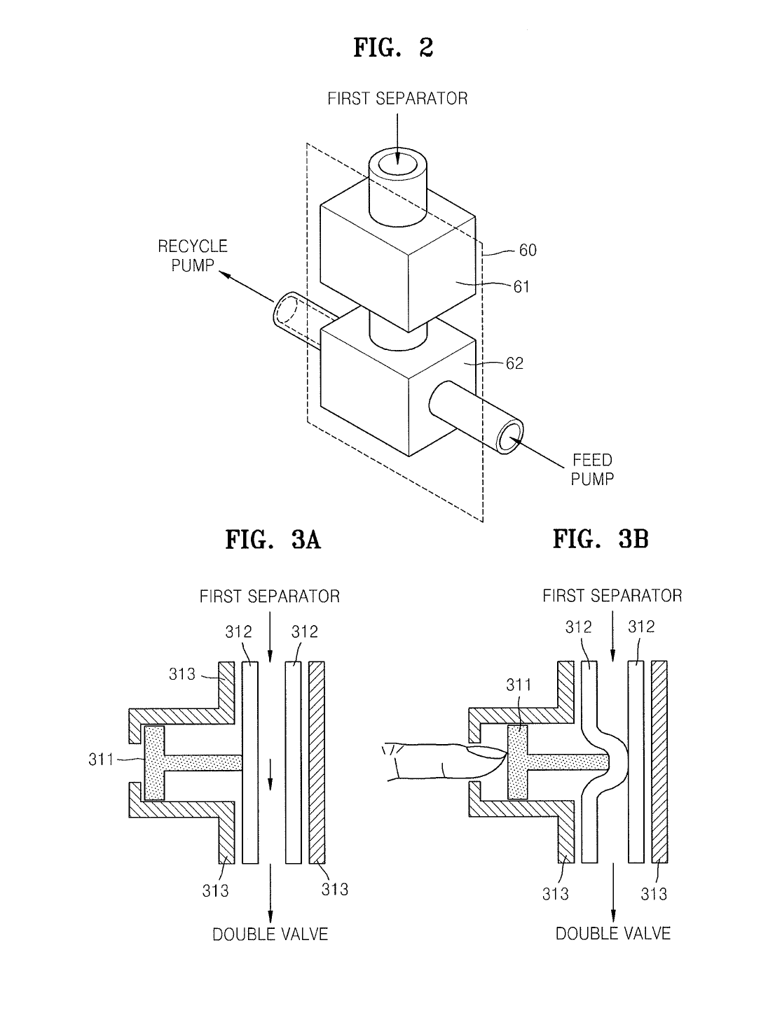

FIG. 2 is an internal configuration diagram of the valve module 60 of FIG. 1. Referring to FIG. 2, the valve module 60 includes a fuel stopper 61 and a double valve 62. The fuel stopper 61 is installed at an outlet of the fuel circulation line 91 through which the low concentration fuel flows, and selectively blocks the flow of the low concentration fuel circulating through the fuel circulation line 91. The double valve 62 is connected to an outlet of the fuel stopper 61 and an outlet of the fuel supply line 92 through which the high concentration fuel flows, and allows at least one of the flow of the low concentration fuel through the fuel circulation line 91 and the flow of the high concentration fuel through the fuel supply line 91 to flow according to whether the flow of the low concentration fuel is blocked by the fuel stopper 61. Specifically, a check valve for preventing a fuel from flowing without regards to the concentration control of the controller 30 may be installed in the double valve 62.

FIGS. 3A and 3B are diagrams of the fuel stopper 61 of FIG. 2, according to an embodiment. Referring to FIGS. 3A and 3B, the fuel stopper 61 includes a button 311 that has a T-shape and that may be moved according to user manipulation, a pipe 312 that is opened or closed according to the movement of the button 311, and a housing 313 for maintaining a combined structure of the button 311 and the pipe 312 shown in FIGS. 3A and 3B. The pipe 312 of the fuel stopper 61 of FIGS. 3A and 3B may be formed of an elastic material, such as a silicone tube. Also, the button 311 may be inserted inside the housing 313 in the fuel stopper 61, and thus the button 311 may be prevented from being manipulated accidentally manipulated by an external object.

FIG. 3A is an internal cross-sectional diagram of the fuel stopper 61 when the button 311 is not pressed by a user. Referring to FIG. 3A, a bar portion of the button 311 is pushed by an elastic force of the pipe 312, and thus a top surface of the button 311 is disposed at the housing 313. Thus, the pipe 312 initially maintains an opened shape, thereby allowing the flow of the low concentration fuel. FIG. 3B is an internal cross-sectional diagram of the fuel stopper 61 when the button 311 is pressed by the user. Referring to FIG. 3B, the button 311 moves toward the pipe 312 as the user presses the button 311, and the pipe 312 is pressed by the bar portion of the button 311. Accordingly, the pipe 312 is closed, thereby blocking the flow of the low concentration fuel.

When the fuel cell system of FIG. 1 is stored for a long period of time or in a dry and hot place, the check valve in the double valve 62 may become locked or the feed pump 44 may be unable to perform the self-priming. Accordingly, it may be impossible to start the fuel cell system. The user may encounter a start failure of the fuel cell system, or may be provided a failure signal through a monitor (not shown), a speaker (not shown), or the like installed in the fuel cell system.

When the user determines that there is a start failure of the fuel cell system, the user presses the button 311 so as to block the flow of the low concentration fuel through the pipe 312, i.e., the flow of the low concentration fuel circulating through the fuel circulation line 91. Accordingly, the recycle pump 43 exerts a pumping force focused on pumping the high concentration fuel supplied through the fuel supply line 92 from the fuel storage unit 20. The fuel flowing through the fuel supply line 92 due to the recycle pump 43 wets the feed pump 44 and the check valve, which may be completely dry, and thus the operation of the feed pump 44 is normalized and the check valve is unlocked. When the fuel cell system is disabled as described above, such a malfunction may be cured by simply pressing the button 311 installed to the fuel cell system without disassembling the fuel cell system. Also, since only a simple mechanical device is added to fix such a malfunction, power consumption is not increased, and a volume of the fuel cell system is not increased.

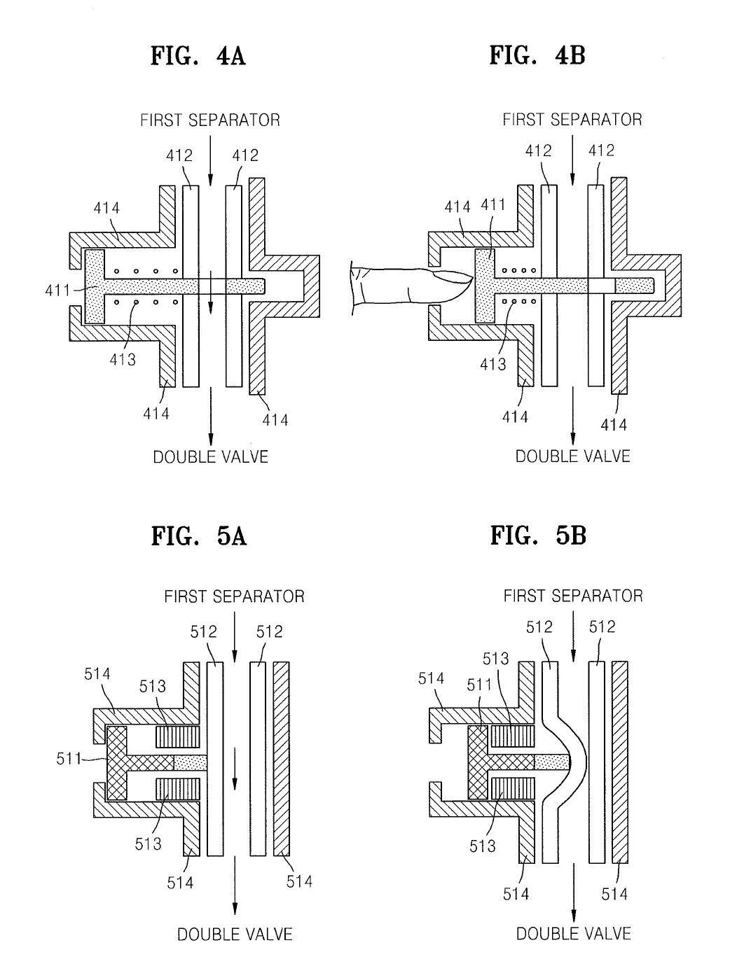

FIGS. 4A and 4B are diagrams of the fuel stopper 61 of FIG. 2, according to another embodiment. Referring to FIGS. 4A and 4B, the fuel stopper 61 includes a button 411 that has a T-shape and that may be moved according to user manipulation, a pipe 412 that is opened or closed according to the movement of the button 411, a spring 412 for maintaining an interval between the button 411 and the pipe 412, and a housing 414 for maintaining a combined structure of the button 411, the pipe 412, and the spring 413 as shown in FIGS. 4A and 4B. The pipe 412 of the fuel stopper 61 shown in FIGS. 4A and 4B may be formed of a metallic material and may be inelastic. Accordingly, the spring 413 for maintaining the interval between the button 411 and the pipe 412 is additionally installed, and a hole is partially formed on a bar portion of the button 411 shown in FIGS. 4A and 4B. Like in FIGS. 3A and 3B, the button 411 is inserted into the housing 414 of the fuel stopper 61 of FIGS. 4A and 4B.

FIG. 4A is an internal cross-sectional view of the fuel stopper 61 when the button 411 is not pressed by the user. Referring to FIG. 4A, the bar portion of the button 411 is pushed by an elastic force of the spring 413, and thus a top surface of the button 411 is placed against the housing 414. Accordingly, the hole of the button 411 is disposed on a path of the pipe 412, thereby allowing the low concentration fuel to flow. FIG. 4B is a cross-sectional view of the fuel stopper 61 when the button 411 is pressed by the user. Referring to FIG. 4B, the button 411 moves toward the pipe 412 when the user presses the button 411, and then the hole of the button 411 is placed outside the path of the pipe 412. Accordingly, the pipe 412 is closed, thereby blocking the low concentration fuel from flowing.

FIGS. 5A and 5B are diagrams of the fuel stopper 61 of FIG. 2, according to another embodiment. Referring to FIGS. 5A and 5B, the fuel stopper 61 includes a button 511 that has a T-shape and that may be moved according to the control of the controller 30, a pipe 512 that is opened or closed according to the movement of the button 511, a solenoid 513 for moving the button 511, and a housing 514 for maintaining a combined structure of the button 511, the pipe 512, and the solenoid 513 as shown in FIGS. 5A and 5B. The pipe 512 of the fuel stopper 61 of FIGS. 5A and 5B may be formed of an elastic material, such as a silicone tube. Like in FIGS. 3A and 3B, the button 511 is inserted into the housing 514 in the fuel stopper 61 of FIGS. 5A and 5B.

When a current flows through the solenoid 513 inside the fuel stopper 61, the solenoid 513 attracts adjacent iron materials. As shown in FIGS. 5A and 5B, a top of the button 511 may be formed of iron and a bottom of the button 511 is not formed of iron. While a current is not flowing through the solenoid, the solenoid 513 surrounds the bottom of the button 511. When a current flows through the solenoid 513, an iron portion at the top of the button 511 is attracted to the solenoid 513 according to a magnetic field inside the solenoid 513.

FIG. 5A is an internal cross-sectional view of the fuel stopper 61 when a signal is not input to the solenoid 513 from the controller 30, i.e., when a current is not flowing through the solenoid 513. Referring to FIG. 5A, a bar portion of the button 511 is pushed by an elastic force of the pipe 512, and thus a top surface of the button 511 is placed at the housing 514. Accordingly, the pipe 512 initially maintains an opened state while allowing the low concentration fuel to flow through. FIG. 5B is an internal cross-sectional view of the fuel stopper 61 when a signal is input to the solenoid 513 from the controller 30, i.e., when a current is flowing through the solenoid 513. Referring to FIG. 5B, the button 511 moves toward the pipe 512 according to a magnetic force of the solenoid 513, and thus the pipe 512 is pressed by the bar portion of the button 511. Accordingly, the pipe 512 is closed, thereby blocking the low concentration fuel from flowing through.

A valve that adjusts opening and closing of a pipe according to an electric signal by using a magnetic field of the solenoid 513 may be referred to as an electrical valve. Thus, the fuel stopper 61 of FIGS. 5A and 5B may be a type of electrical valve. The fuel stopper 61 of FIGS. 4A and 4B may be realized as an electrical valve having a structure similar to that shown in FIGS. 5A and 5B. Meanwhile, the fuel stoppers 61 of FIGS. 3A, 3B, 4A and 4B allow an operation failure of the fuel cell system to be manually fixed, whereas the fuel stopper 61 of FIGS. 5A and 5B automatically fixes the operation failure of the fuel cell system.

For example, when the check valve inside the double valve 62 is locked or the feed pump 44 is unable to perform the self-priming, only the low concentration fuel is supplied to the mixer 70 through the fuel circulation line 91, and the high concentration fuel is not supplied through the fuel supply line 92. Accordingly, a concentration of a fuel detected by the sensor 80 is low. When the concentration of the fuel detected by the sensor 80 is lower than or equal to a predetermined value, the controller 30 determines that the high concentration fuel is not supplied well through the fuel supply line 92 and directs a current to flow through the solenoid 513. As a result, the flow of the low concentration fuel is blocked when the pipe 512 is closed, and the pumping exertion of the recycle pump 43 is focused the high concentration fuel supplied through the fuel supply line 92.

Alternatively, in order to supply a fuel having a concentration demanded by the fuel cell 10, the controller 30 may adjust an opening degree of the pipe 512 by adjusting an interval in which a current through the solenoid 513 flows by referring to a current concentration of the fuel detected by the sensor 80. Accordingly, the fuel cell system may adjust an amount of the low concentration fuel flowing through the pipe 512, thereby adjusting the concentration of the fuel demanded by the fuel cell 10 flowing through the mixer 70.

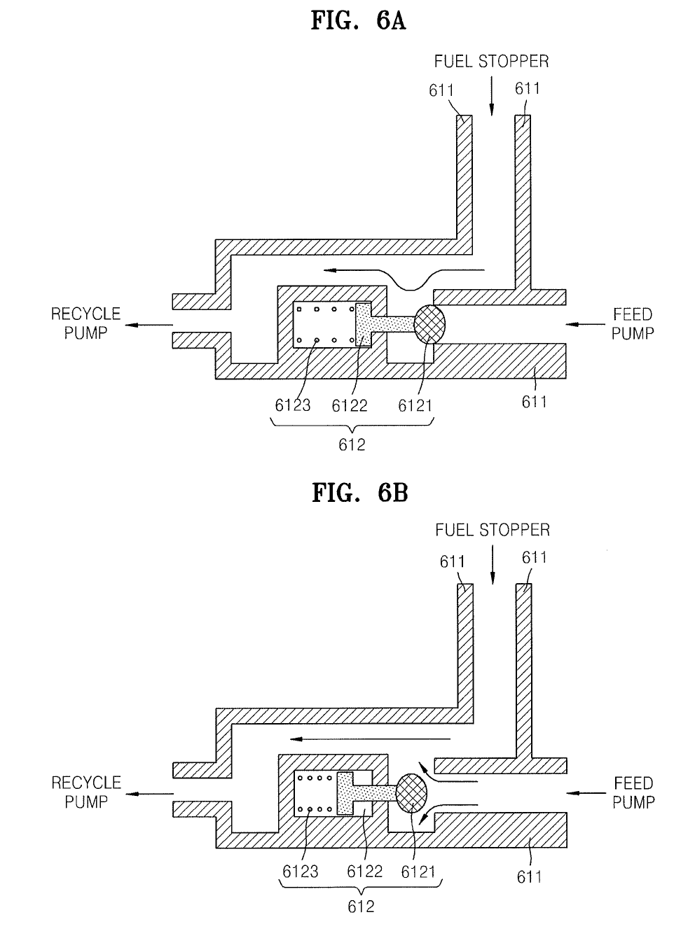

FIGS. 6A and 6B are diagrams of the double valve 62 of FIG. 2, according to an embodiment. Referring to FIGS. 6A and 6B, the double valve 62 includes a housing 611 that includes a first path through which the low concentration fuel discharged from the fuel stopper 61 flows, a second path through which the high concentration fuel discharged from the feed pump 44 flows, and a common outlet for discharging a fuel flowed from the first and second paths to the recycle pump 42. A check valve 612 is inserted into the second path and is opened according to a size of an inflow pressure of the high concentration fuel.

The check valve 612 includes a ball 6121 that moves according to the amount of the inflow pressure of the high concentration fuel discharged from the feed pump 44, a bar 6122 for supporting the ball 6121, and a spring 6123 for pressing the bar 6122. The housing 611 for supporting a combined structure of the ball 6121, the bar 6122, and the spring 6123 as shown in FIGS. 6A and 6B may be manufactured integrally with the combined structure or separately from the combined structure.

FIG. 6A is an internal cross-sectional view of the double valve 62 when the inflow pressure of the high concentration fuel from the feed pump 44 to the double valve 62 does not exceed an elastic force of the spring 6123 pressing the bar 6122. Referring to FIG. 6A, the ball 6121 is pushed to an outlet of the second path according to the elastic force of the spring 6123, and thus the ball 6121 blocks the outlet of the second path. Accordingly, the second path is closed, thereby blocking the flow of the high concentration fuel. FIG. 6B is an internal cross-sectional view of the double valve 62 when the inflow pressure of the high concentration fuel from the feed pump 44 to the double valve 62 exceeds the elastic force of the spring 6123 pressing the bar 6122. Referring to FIG. 6B, the ball 6121 is spaced apart from the outlet of the second path by the inflow pressure of the high concentration fuel, and the high concentration fuel flowed in from the feed pump 44 is discharged through a space between the ball 6121 and the outlet of the second path.

Since the check valve 612 of FIGS. 6A and 6B may be installed at a point where the first path through which the low concentration fuel flows and the second path through which the high concentration fuel flows meet, the low concentration fuel flowing through the first path may wet the check valve 612 even when the high concentration fuel flowing through the second path is dried out. Since the low concentration fuel contains less methanol than the high concentration fuel, the low concentration fuel is not easily evaporated despite long storage in a hot place. Accordingly, the locking of the check valve 612 due to the dried out ball 6121 in the check valve 612 may be prevented.

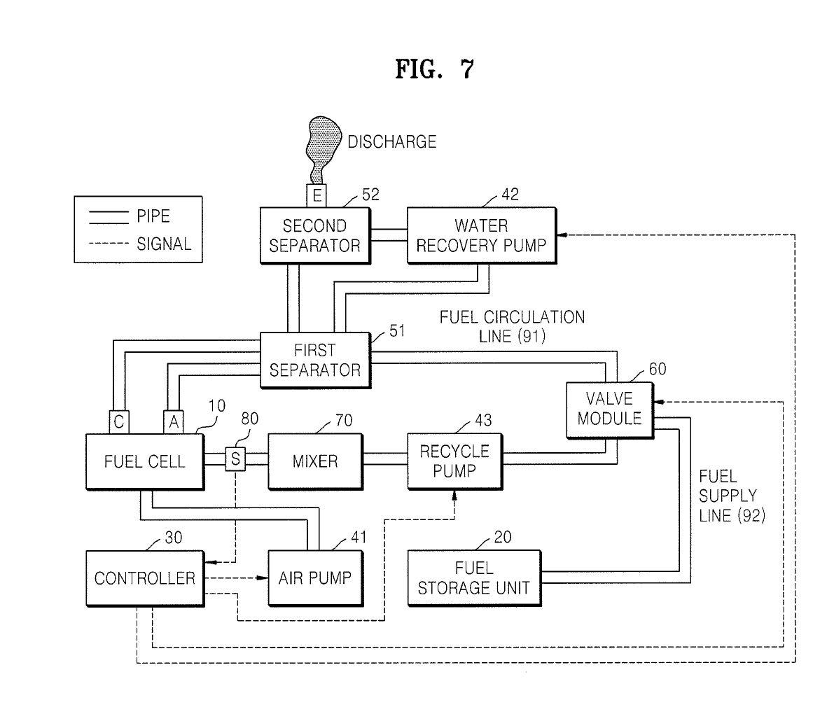

FIG. 7 is a block diagram of a fuel cell system according to another embodiment. The fuel cell system of FIG. 7 has the same structure as the fuel cell system of FIG. 1, except that the fuel cell system of FIG. 7 does not include the feed pump 44. The feed pump 44 may be omitted if the recycle pump 43 by itself is able to pump the high concentration fuel from the fuel storage unit 20 through the check valve 612 inside the double valve 61 of FIGS. 6A and 6B.

When the check valve 612 in the double valve 62 is omitted, the recycle pump 43 by itself may pump the high concentration fuel from the fuel storage unit 20 even if the suction force of the recycle pump 43 is not large. In this case, functions of the check valve 612 may be performed by an electrical valve, so as to prevent the fuel from flowing without regards to the concentration control of the controller 30. Here, the valve module 60 may include at least one electrical valve for controlling the flow of the low concentration fuel circulating the fuel cell 10 through the fuel circulation line 91 and the flow of the high concentration fuel supplied from the fuel storage unit 20 to the fuel cell 10 through the fuel supply line 92.

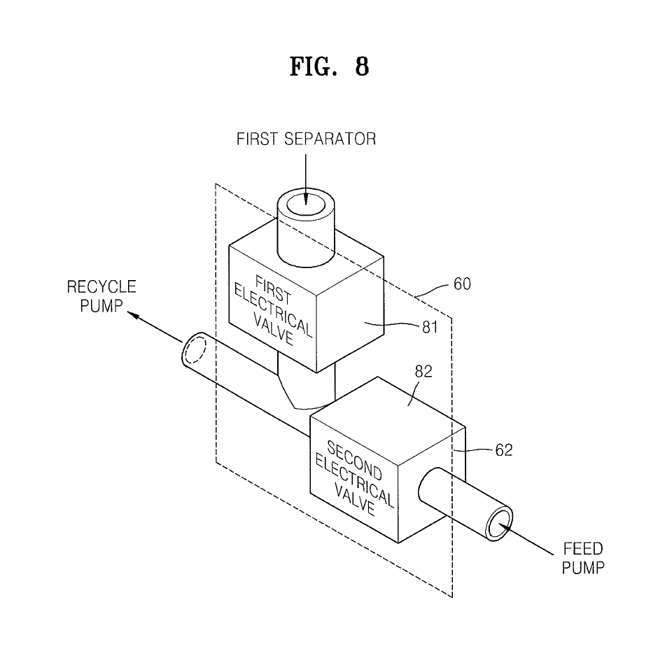

FIG. 8 is a diagram of the valve module 60 used in the fuel cell system of FIG. 7, according to an embodiment. The valve module 60 of FIG. 8 is designed to control the flow of the low concentration fuel circulating through the fuel circulation line 91 and the flow of the high concentration fuel supplied through the fuel supply line 92 by using two electrical valves. Referring to FIG. 8, the valve module 60 includes a first electrical valve 81 and a second electrical valve 82. The first electrical valve 81 controls the flow of the low concentration fuel circulating the fuel cell 10 through the fuel circulation line 91 according to the control of the controller 30. The second electrical valve 82 controls the flow of the high concentration fuel supplied from the fuel storage unit 20 to the fuel cell 10 through the fuel supply line 92 according to the control of the controller 30. Each of the first and second electrical valves 81 and 82 may have the structure shown in FIGS. 5A and 5B.

In order to supply a fuel having a concentration demanded by the fuel cell 10, the controller 30 may control the first and second electrical valves 81 and 82 by referring to a current concentration of a fuel detected by the sensor 80, thereby adjusting an amount of the low concentration fuel flowing into the mixer 70 through the fuel circulation line 91 and an amount of the high concentration fuel flowing into the mixer 70 through the fuel supply line 92. Accordingly, the fuel cell system adjusts the amounts of the low concentration fuel and high concentration fuel flowing into the mixer 70, thereby obtaining the concentration demanded by the fuel cell 10.

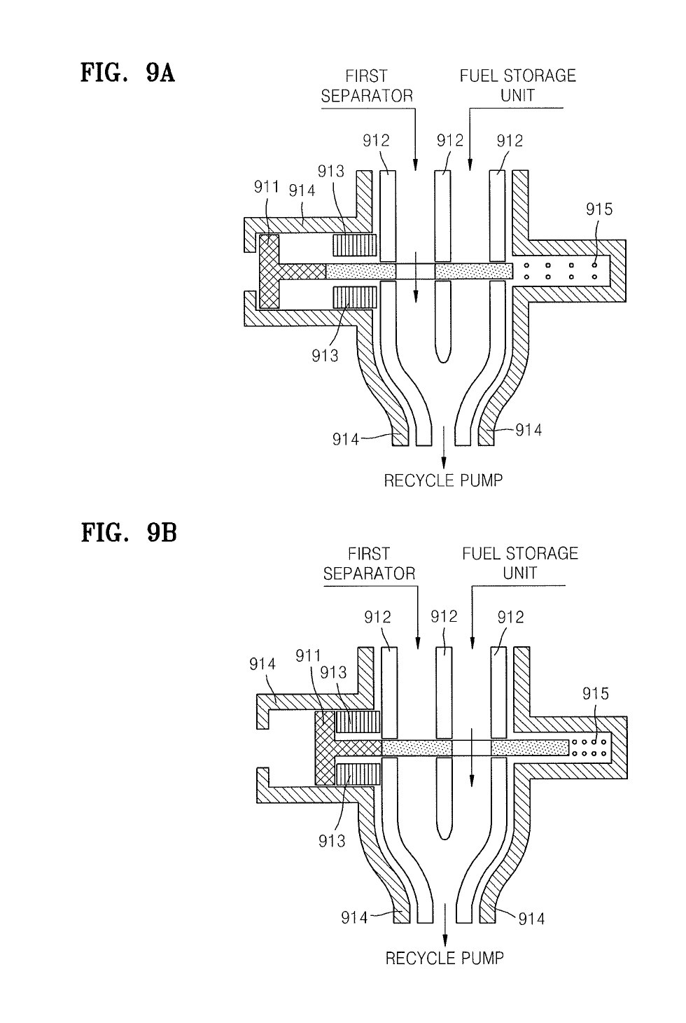

FIGS. 9A and 9B are diagrams of the valve module 60 used in the fuel cell system of FIG. 7, according to another embodiment. The valve module 60 of FIGS. 9A and 9B is designed to control the flow of the low concentration fuel circulating through the fuel circulation line 91 and the flow of the high concentration fuel supplied through the fuel supply line 92 by using one electrical valve. The electrical valve of FIGS. 9A and 9B is a type of a three-way valve, and may be replaced by a commercial three-way valve having another shape and performing the same functions. Referring to FIGS. 9A and 9B, the valve module 60 includes a button 911 that has a T-shape and that moves according to the control of the controller 30, a double pipe 912 that allows the flow of the low concentration fuel while blocking the flow of the high concentration fuel or blocks the flow of the low concentration fuel while allowing the flow of the high concentration fuel according to the movement of the button 911, a solenoid 913 for moving the button 911, and a housing 914 for maintaining a combined structure of the button 911, the double pipe 912, and the solenoid 913 as shown in FIGS. 9A and 9B. The double pipe 912 of FIGS. 9A and 9B may be formed of a metallic material and may be inelastic. Accordingly, a spring 915 for maintaining an interval between the button 911 and the double pipe 912 is additionally installed, and a hole is partially formed on a bar portion of the button 911.

A top of the button 911 is formed of iron and a bottom of the button 911 is not formed of iron. The solenoid 513 surrounds the bottom of the button 511 when a current is not flowing through the solenoid 513. When a current flows through the solenoid 513, the top of the button 511 formed of iron is attracted to the solenoid 513 by a magnetic field inside the solenoid 513.

FIG. 9A is an internal cross-sectional view of the valve module 60 when a signal is not input to the solenoid 913 from the controller 30, i.e., when a current is not flowing through the solenoid 913. Referring to FIG. 9A, the bar portion of the button 911 is pushed by an elastic force of the spring 915, and thus a top surface of the button 911 is placed at the housing 914. Accordingly, the hole of the button 911 is placed in a path of the low concentration fuel of the double pipe 912, thereby allowing the flow of the low concentration fuel while blocking the flow of the high concentration fuel. FIG. 9B is an internal cross-sectional view of the valve module 60 when a signal is input to the solenoid 913 from the controller 30, i.e., when a current is flowing through the solenoid 913. Referring to FIG. 9B, the button 911 moves toward the double pipe 912 according to a magnetic force of the solenoid 913. Accordingly, the hole of the button 911 is placed in a path of the high concentration fuel of the double pipe 912, thereby allowing the flow of the high concentration fuel while blocking the flow of the low concentration fuel.

In order to supply a fuel having a concentration demanded by the fuel cell 10, the controller 30 may adjust an interval in which a current through the solenoid 513 flows by referring to a current concentration of a fuel detected by the sensor 80, thereby adjusting a section where the low concentration fuel flows through the double pipe 912 and a section where the high concentration fuel flows through the double pipe 912. Accordingly, the fuel cell system is able to adjust the amounts of the low concentration fuel and high concentration fuel flowing into the mixer 70, thereby obtaining the concentration demanded by the fuel cell 10.

As described above, according to the one or more of the above embodiments, a starting failure of a fuel cell caused by storing a fuel cell system for a long time or in a hot dry place may be cured by improving fuel supply to the fuel cell.

It should be understood that the exemplary embodiments described therein should be considered in a descriptive sense only and not for purposes of limitation. Descriptions of features or aspects within each embodiment should typically be considered as available for other similar features or aspects in other embodiments.

What is claimed is:

1. A fuel cell system, comprising:
a fuel cell for generating electric power by using a fuel;
a valve module for controlling a flow of a low concentration fuel circulating through the fuel cell, and a flow of a high concentration fuel supplied from a fuel storage unit to the fuel cell;
a pump for pumping at least one of the low concentration fuel and the high concentration fuel according to a fuel flow control of the valve module; and
a mixer for mixing and supplying the low concentration fuel and the high concentration fuel pumped from the pump to the fuel cell.

2. The fuel cell system of claim 1, wherein the valve module manually controls the flow of the low concentration fuel and the flow of the high concentration fuel according to a manipulation of a user.

3. The fuel cell system of claim 1, wherein the valve module automatically controls the flow of the low concentration fuel and the flow of the high concentration fuel according to a concentration of a fuel supplied to the fuel cell.

4. The fuel cell system of claim 1, wherein, when the flow of the high concentration fuel is less than a predetermined value, the valve module increases the flow of the high concentration fuel by blocking the flow of the low concentration fuel such that a greater pumping force is exerted with respect to the high concentration fuel.

5. The fuel cell system of claim 1, further comprising a controller for controlling fuel supply to the fuel cell, and wherein the valve module includes at least one electrical valve for controlling the flow of the low concentration fuel and the flow of the high concentration fuel according to a control of the controller.

6. The fuel cell system of claim 5, wherein the valve module includes:
a first electrical valve for controlling the flow of the low concentration fuel according to the control of the controller; and
a second electrical valve for controlling the flow of the high concentration fuel according to the control of the controller.

7. The fuel cell system of claim 5, wherein the valve module includes an electrical valve that allows the flow of the low concentration fuel while blocking the flow of the high concentration fuel, or blocks the flow of the low concentration fuel while allowing the flow of the high concentration fuel, according to the control of the controller.

8. A valve module for controlling a flow of a low concentration fuel circulating through a fuel cell and a flow of a high concentration fuel supplied from a fuel storage unit to the fuel cell, the valve module including:
a fuel stopper for selectively blocking the flow of the low concentration fuel; and
a double valve for allowing at least one of the flow of the low concentration fuel and the flow of the high concentration fuel according to the blocking of the fuel stopper.

9. The valve module of claim 8, wherein the fuel stopper includes:
a button that moves according to a manipulation of a user; and
a pipe that is opened or closed according to the movement of the button.

10. The valve module of claim 8, further comprising a controller for controlling fuel supply to the fuel cell, wherein the fuel stopper includes a button that moves according to the control of the controller, and a pipe that is opened or closed according to the movement of the button.

11. The valve module of claim 8, wherein the double valve includes:
a first path through which the low concentration fuel flows and a second path through which the high concentration fuel flows, wherein outlets of the first and second paths are connected to an inlet of a pump, and
a check valve disposed in the second path, the check valve being opened according to a size of an inflow pressure of the high concentration fuel.

12. The valve module of claim 11, wherein the check valve is disposed at a location where the first path and the second path meet, and is positioned to be wetted by the low concentration fuel flowing through the first path.
